(19) United States
(12) Patent Application Publication
(10) Pub. No.: US 2021/0334755 A1
(43) Pub. Date: Oct. 28, 2021

(54) Systems and Methods for Organizing Materials Relating to a Project

(71) Applicant: Kristina Johnson, Midland, TX (US)

(72) Inventor: Kristina Johnson, Midland, TX (US)

(21) Appl. No.: 17/318,885

(22) Filed: May 12, 2021

Related U.S. Application Data
(63) Continuation-in-part of application No. 16/032,160, filed on Jul. 11, 2018, now abandoned.
(60) Provisional application No. 62/531,210, filed on Jul. 11, 2017.

(51) Int. Cl. G06Q 10/10; G06F 3/0482

(52) U.S. Cl. CPC G06Q 10/103; G06Q 50/165; G06F 3/0482; G06Q 10/101

(57) ABSTRACT

A system and method of managing a project implemented on a server system includes providing a database having at least one project that has first and second identifiers that are different. The project retains project items that have any combination of said first and second identifiers. At least one first identifier is interconnected to at least one of said second identifier in each said project item. Selecting a first project identifier from said project shows project items containing the selected project identifier as a first display. Selecting a second project identifier from said first display shows project items containing said selected second project identifier as a second display. The project items shown in said second display may include at least one of said project items from said first display. Spec sheets or the like can be produced from the first and/or second displays.

### FOREIGN PRIORITY CLAIM

The present application is a continuation-in-part of U.S. Non-Provisional patent application Ser. No. 16/032,160, filed on Jul. 11, 2018, which claims benefit under 35 U.S.C. 119(e) of U.S. Provisional Patent Application No. 62/531,210 filed on Jul. 11, 2017, entitled “Systems and Methods for Organizing Materials Relating to a Home Building or Remodeling Project,” the entire contents of both are incorporated herein by reference as if set fully herein.

### FIELD OF THE INVENTION

The present disclosure generally relates to organizing materials, and more particularly to organizing and managing materials relating to a project such as a home building or remodeling project.

### BACKGROUND OF THE INVENTION

It is sometimes difficult to keep track of information, including budget, timeline, designs and inspirational images, related to a home building or remodeling project. The information can originate from different sources that need to be integrated to ensure a successful project. Further, storage and later retrieval/sharing/management of the information—even when stored in digital form—can present challenges.

### SUMMARY OF THE INVENTION

It is sometimes difficult to keep track of information, including budget, timeline, designs and inspirational images, related to a home building or remodeling project. The information can originate from different sources that need to be integrated to ensure a successful project. Further, storage and later retrieval/sharing/management of the information—even when stored in digital form—can present challenges.

Systems and methods according to embodiments of the present disclosure may provide an Internet-based application for a user to keep track of information, including budget, timeline, designs and inspirational images, related to a home building or remodeling project. The information can originate from different sources and can be integrated within the Internet-based application to ensure a successful project. Using the application, information may be stored for later retrieval/sharing/management of the information. A user may upload and tag images of selections, track the budget for a home project, manage the timeline, print or otherwise transmit spec sheets to an architect or builder, export the project to another platform, and/or share the project with others using an Internet-based application. Accordingly, using an application according to embodiments of the present disclosure, a user may access information related to the home building or remodeling project while on the go, such as at the home site, during meetings with builders/architects/interior designers, and/or at a home goods store when searching for materials related to the project.

Embodiments of the present disclosure may provide an Internet-based method for organization relating to a home building or remodeling project comprising: identifying the home building or remodeling project from a list of one or more projects within a mobile application accessible via the Internet; customizing a plurality of topics relating to the home building or remodeling project; uploading one or more images or videos; associating the one or more images or videos with at least one of the plurality of topics and at least one physical location within the at least one of the plurality of topics; and viewing at least one view of the home building or remodeling project, the at least one view selected from the group comprising: a timeline view to show days that have passed since the home building or remodeling project began or days remaining before scheduled to be finished, a sanity view to provide other users working on the home building or remodeling project a real-time indication as to how a user feels about the home building or remodeling project, and a budget view. The plurality of topics may be pre-loaded within the mobile application. Customizing topics may include adding additional topics. The one or more images or videos may be uploaded to the mobile application via a user's camera within his/her mobile phone or tablet. The method also may include viewing at least one of the one or more images or videos based on the plurality of topics or the at least one physical location; and commenting on the at least one of the one or more images or videos. The method may further include sharing the home building or remodeling project with at least one other user via the mobile application accessible via the Internet. The method may include producing at least one specification sheet based on the plurality of topics, the one or more images or videos, and the at least one physical location relating to the home building or remodeling project. The one or more projects may be sorted between a user's projects and projects that have been shared with the user by at least one other user. The at least one physical location may be selected from the group comprising: entry, exterior, master bedroom, great room, master bathroom, guest bathroom, guest bedroom, kitchen, laundry room, mud room, spare bedroom, child's bedroom, and staircase. The plurality of topics may be selected from the group comprising: countertops, flooring, hardware, furniture, windows, ceiling treatments, floor plan sketches, glass and mirrors, lighting, inspirational images, and doors.

Other embodiments of the present disclosure may include an Internet-based method for organization relating to a project comprising: identifying the project from a list of one or more projects through a graphical user interface within a mobile application accessible via the Internet, wherein the project includes one or more sub-categories; uploading one or more images or videos to the project; tagging the one or more images or videos to the one or more sub-categories within the project; and sorting the one or more images or videos based upon defined parameters for the project, wherein the project may be selected from the group comprising: recipes, family photographs and/or videos, video and/or photographs from friends, clothing, accessories, vacation or event places, decor or furnishing categories, personal data management categories, and interconnected projects and categories. The one or more projects may be user-defined or administrator-defined. The method may further include conducting multi-level searches of the one or more projects and the one or more sub-categories to locate one or more images or videos within the mobile application.

Further embodiments of the present disclosure may be directed to an Internet-based method for organization relating to a home building or remodeling project comprising: identifying the home building or remodeling project from a list of one or more projects within a mobile application accessible via the Internet, wherein the one or more projects are sorted between a user's projects and projects that have been shared with the user by at least one other user; customizing a plurality of topics relating to the home building or remodeling project; uploading one or more images or videos, wherein the one or more images or videos are upload to the mobile application via a user's camera within bis/her mobile phone or tablet; associating the one or more images or videos with at least one of the plurality of topics and at least one physical location within the at least one of the plurality of topics; viewing at least one of the one or more images or videos based on the plurality of topics or the at least one physical location; and commenting on the at least one of the one or more images or videos. The method also may include viewing a timeline view of the home building or remodeling project to show days that have passed since the home building or remodeling project began or days remaining before scheduled to be finished. The method may further include viewing a sanity view to provide other users working on the home building or remodeling project a real-time indication as to how a user feels about the home building or remodeling project. The method may include viewing a budget view to track and manage the budget relating to the home building or remodeling project. The method may also include sharing the home building or remodeling project with at least one other user via the mobile application accessible via the Internet. The one or more images or videos and comments may originate from more than one source.

A method of managing a project implemented on a server system includes defining a project in a database, said project having project identifiers, said project identifiers being first identifiers and second identifiers. The first identifiers and second identifiers are different from each other and may be hubs and spokes. Project items such as but not limited to photos, documents, building plans, etc. are uploaded to the project in the database. Each project item has at least one first identifier and at least one second identifier and at least one first identifier is interconnected to at least one second identifier in each said project item. Selecting a first project identifier from said project produces a first display of project items containing the selected first project identifier. A second project identifier can be selected from said first display to produce a second display having project items containing said selected second project identifier. The project items in said second display may include at least one of said project items from said first display. The first display and/or the second display can be presented as a product such as a PDF document, Spec sheet, photo album, moodboards, etc. The product can sort said first display and/or said second display based on project item.

An information processing method operated by at least one processor by executing a program stored in at least one memory, the method comprising the steps of defining a project in a database, said project having project identifiers being first identifiers and second identifiers. The first identifiers and second identifiers are different from each other. Project items are uploaded to or stored in the project in the database. Each project item has at least one first identifier and at least one second identifier. At least one of said first identifier is interconnected to at least one of said second identifier in each said project item. Selecting a first project identifier from said project shows project items containing the selected project identifier as a first display. Selecting a second project identifier from said first display shows project items containing the selected second project identifier as a second display. The project items in said second display may include at least one project item from said first display. The first display and/or the second display can be presented as a product such as a PDF document, Spec sheet, photo album, moodboards, etc. The product can sort said first display and/or said second display based on project item.

The present invention provides insight into productive organizational methods involving a curated, invertible system of categorization and labeling. The invention permits the user flexibility of defining relationships between organizational units using identifiers and manages these relationships so user have access to a simplified, directed workflow. The user is able to invert organizational units, as well as customize how they are presented. The net effect is a unique presentation that allows the user to access information in a manner that is more efficient than prior art methods, while still being flexible enough to follow the user's specific workflow needs. Additionally, project items that are sorted using the interconnected identifiers in the present system are able to be represented statically on-demand and shared via a generated document. The hierarchical nature of the items is “flattened” and rendered in list form with various media options, examples of the rendering include but are not limited to PDF documents, a moodboard, spec sheet, photo albums, etc.

### DESCRIPTION OF THE DRAWINGS

For a more complete understanding of this disclosure, reference is now made to the following description, taken in conjunction with the accompanying drawings, in which:

FIGS. 1A-1D depict screenshots for customization of selections according to an embodiment of the present disclosure;

FIGS. 2A-2F depict screenshots for uploading and tagging images according to an embodiment of the present disclosure; and

FIGS. 3A-3F depict screenshots of systems and methods to view images and make comments according to an embodiment of the present disclosure.

FIG. 4 is a schematic block diagram illustrating an embodiment of the present invention.

FIG. 5 shows system components involved in an embodiment of the present invention.

FIG. 6 illustrates one example of a computer system that can be used to implement various embodiments described and illustrated herein.

### DETAILED DESCRIPTION OF THE INVENTION

Embodiments of the present disclosure may provide systems and methods for organization when building a home or tackling a remodeling project. Systems and methods may provide a user with the ability to upload and tag images of selections, track the budget for a home project, manage the timeline, print or otherwise transmit spec sheets to an architect or builder, export the project to another platform, and/or share the project with others using an Internet-based application. The application may be used on a pc or a mobile application that may be accessed by a user over the Internet via his/her mobile phone or tablet. Accordingly, a user may access information related to the home building or remodeling project while on the go, such as at the home site, during meetings with builders/architects/interior designers, and/or at a home goods store when searching for materials related to the project.

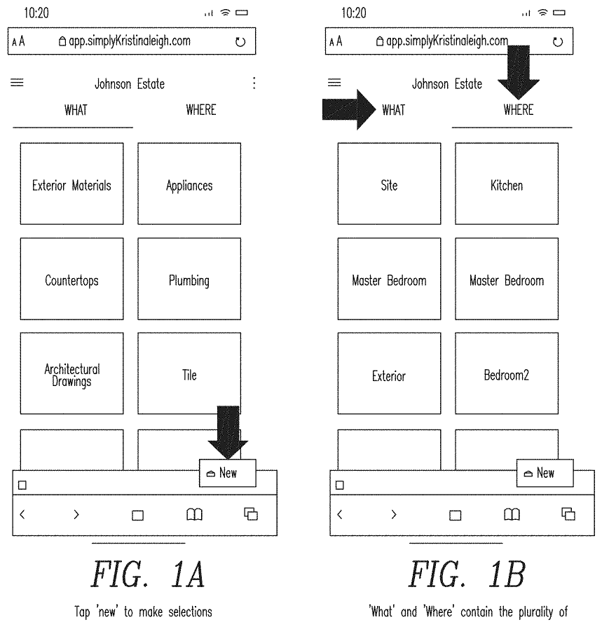

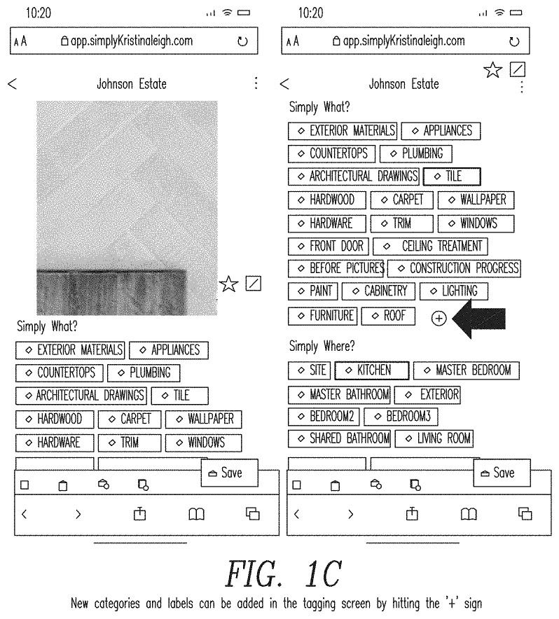

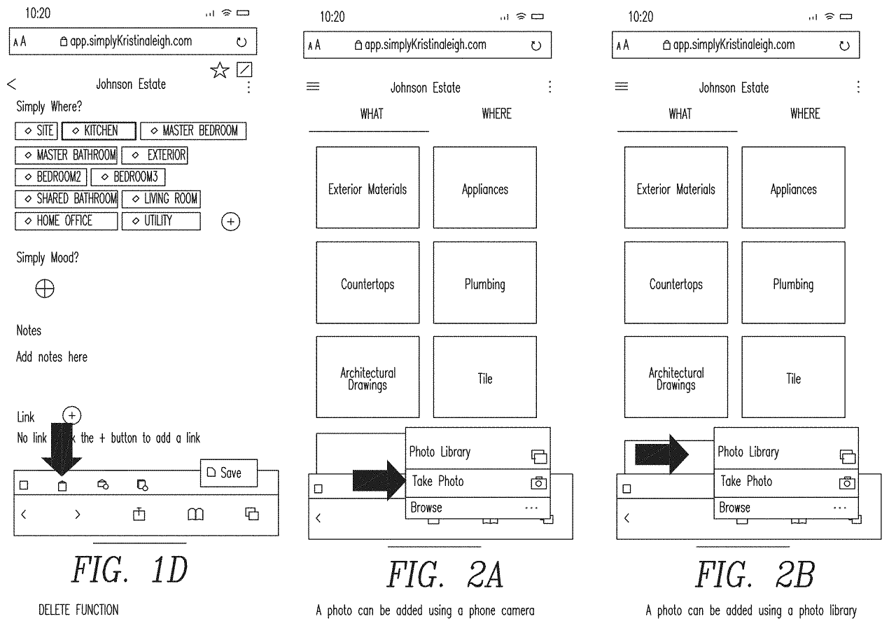

Embodiments of the present disclosure may allow a user to keep track of materials and inspirational designs as a home building or remodeling project develops. In some embodiments of the present disclosure, the application may be pre-loaded with selections, and a user may customize topics that he/she wishes to add or delete those that the user may not need. Users may add or delete selections of items including, but not limited to, furniture, art or shower details. For example, if the application is being used for a bathroom remodeling project, the user may not need to select art or furniture for the bathroom, and accordingly, the user may delete certain pre-loaded selections for that project. On the other hand, if the user is embarking on a home building project, the user may need to utilize all pre-loaded selections, and perhaps may wish to add additional selections. This customization of selections may be done on a project-by-project basis, as illustrated in more detail in FIGS. 1A-1D.

FIGS. 1A-1D depict screenshots for customization of selections according to an embodiment of the present disclosure. A “selections” or “new” button or input mechanism may be provided in FIG. 1A, and a user may select the “selections” or “new” button. In FIG. 1B, a user may be presented with a plurality of topics from which to select. These topics may include, but are not limited to, rooms, inspirational images, biggies, appliances, backsplashes, built-ins, ceiling treatments, countertops, floor plan sketches, flooring, furniture, glass and mirrors, hardware, interior doors, and light features. A user may add a topic or category by selecting the “+” symbol or another input mechanism that may be presented on the screen. A pop-up input box may be presented such as is depicted in FIG. 1C, and the user may enter a new category through a keyboard. However, other input mechanisms, including but not limited to, voice input and drop-down menus, may be used to enter a new category without departing from the present disclosure. When the user finishes enter the name of his/her new category, the “add” or “save” button may be selected. FIG. 1D depicts a mechanism for deleting an existing category according to an embodiment of the present disclosure. In this embodiment, a user may swipe left or click on the trash can icon to delete button; however, other mechanisms for deletion may be utilized without departing from the present disclosure.

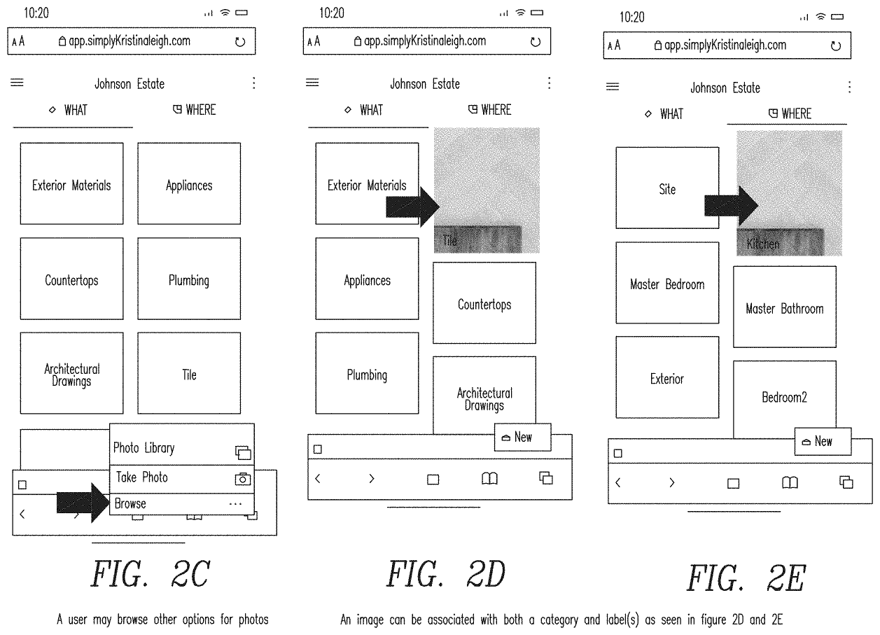

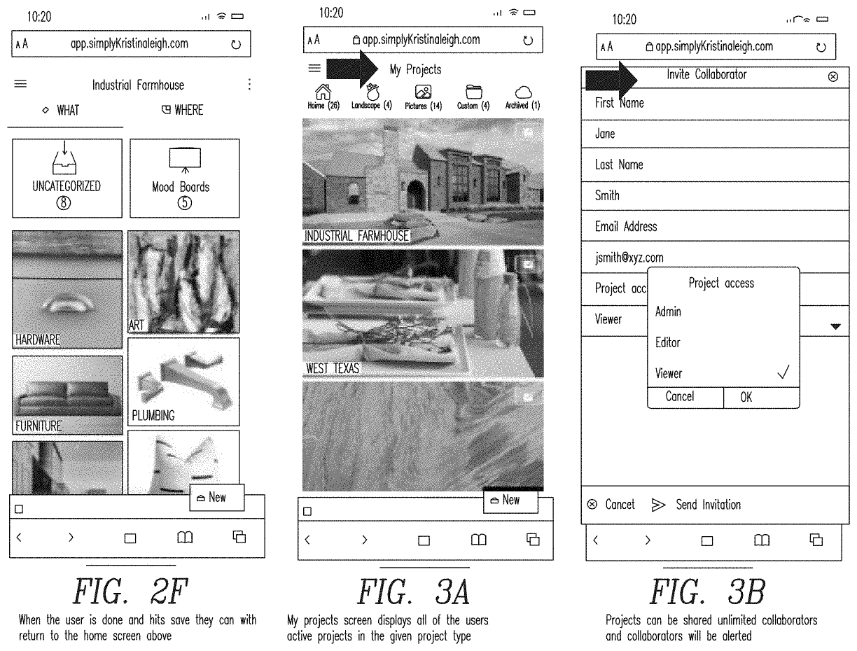

During a home building or remodeling project, it is important for selections to be organized. Systems and methods according to an embodiment of the present disclosure may provide a user with the ability to upload and tag his/her images so that they may be retrieved at a later time during the building or remodeling project. FIGS. 2A-2F depict screenshots for uploading and tagging images according to an embodiment of the present disclosure. In FIG. 2A, a user may select an option to utilize camera on his/her phone. As depicted in FIG. 2B, no image has been uploaded, but a user may click on the “+” symbol or otherwise tap/select an icon to upload an image from photos saved by the user. Additionally or alternatively, the user may use the camera on his/her phone to take a photo to be utilized. In FIG. 2C, the user may be presented with one or more options to select an image to be uploaded. In this embodiment of the present disclosure, the user may select “camera” or “photo library” to select the source image. On an image has been selected, in FIG. 2D, the user may select one or more categories (tags or identifier) to associate with the image. In this embodiment of the present disclosure, the user may assign the image to the “countertops” category. Once a category has been selected, the user may be presented with one or more locations within the category to associate the image. As depicted in FIG. 2E, the user may select the “kitchen” location in the “tile” category to associate the image. It should be appreciated that the user may select more than one location to associate the image (i.e., if the user wishes to use the same countertop in the “master bath” location as well as in the “girl's shared bathroom” and/or “guest bathroom” locations). After the user has associated the image with one or more categories and one or more locations, the user may lock in the selections in FIG. 2F, such as by selecting the “save” button when the user is satisfied with his/her selections and can navigate back to the home screen.

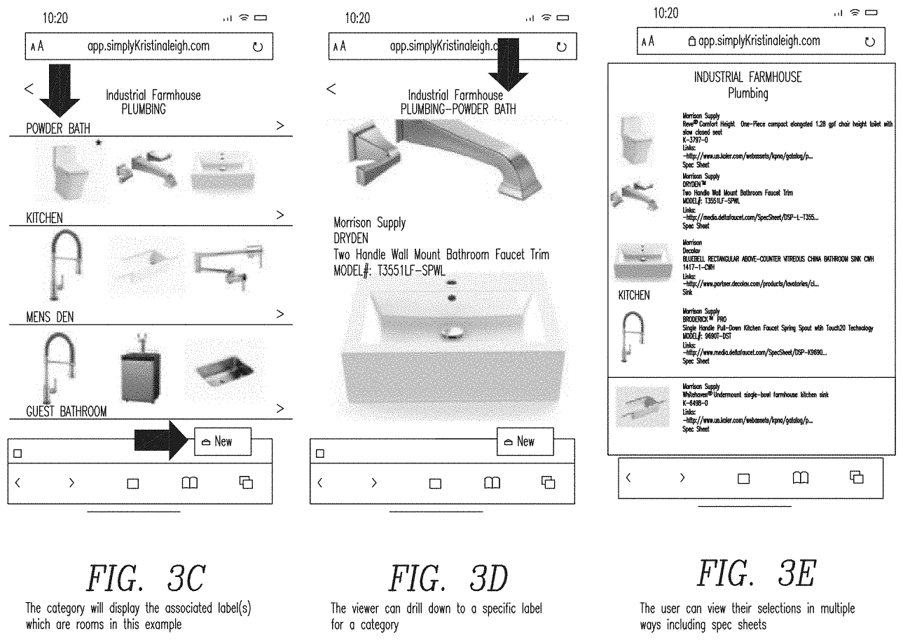

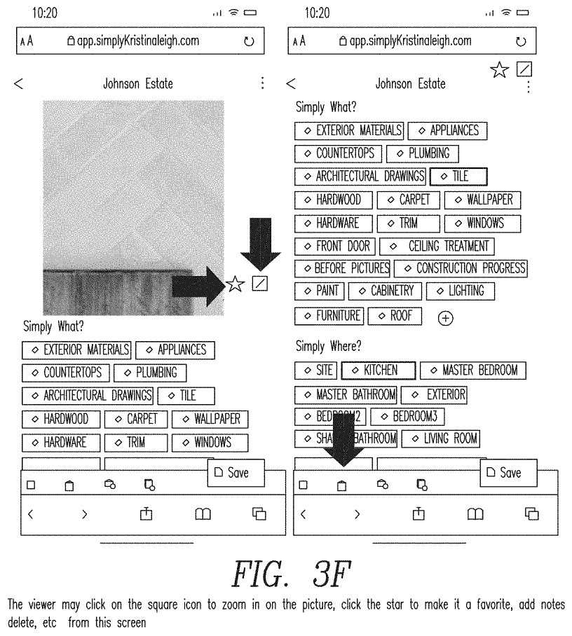

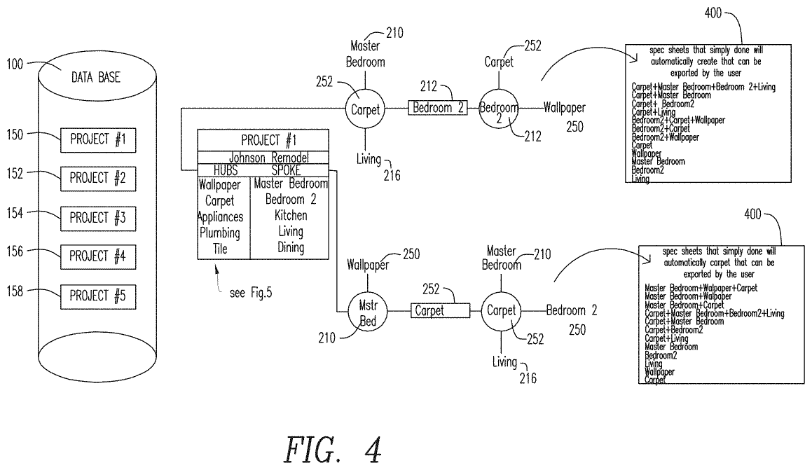

Systems and methods according to embodiments of the present disclosure may allow a user to view images and make comments. A user may view images by topic and/or by room, add notes and comments, export the project to another platform, share his/her project with other users, and/or produce specification sheets that may be printed or otherwise transmitted. FIGS. 3A-3F depict screenshots of systems and methods to view images and make comments according to an embodiment of the present disclosure. In FIG. 3A, a user may be presented with one or more selections including, but not limited to, “overview,” “projects,” and “alerts.” A user may select the “overview” button to get to his/her home screen within the application. FIG. 3B will describe further what is depicted when the user selects the “collaborators” button. If there is an alert associated with one or more projects, those alerts may be viewed by selecting the “alerts” button. It should be appreciated that the alerts may be organized by project or by other categories of alerts without departing from the present disclosure.

When a user selects the “projects” button depicted in FIG. 3A, the user may be presented with one or more projects. These projects may be sorted between the user's own projects and projects that have been shared with the user by others. If the user selects one of his/her own projects, the user may be directed to the home screen associated with that project. When the user selects a project that has been shared, the user may be presented with one or more categories associated with the project. For example, if a home building project has been shared with the user, the user may be able to view one or more categories including, but not limited to, rooms, inspirational images, backsplashes, light fixtures, and countertops. If the user selects the “rooms” category, for example, the user may then be presented with a list of rooms. One of the rooms may be the entry, and upon selection of “entry,” the user may be able to view images of ceiling treatments, flooring, glass and mirrors and hardware that another user has selected for his/her home building project. The user may be inspired by the other user's selections and could inquire with the other user about the selection. Additionally or alternatively, the user may provide comments to the other user about his/her selections. It should be appreciated that the other user's selections may be organized based on his/her top choice as well as other options in some embodiments of the present disclosure. It also should be appreciated that when the user is viewing the images of another user, the user also may be able to view the other user's comments on the images in some embodiments of the present disclosure.

FIG. 3B depicts a home screen within the application. This home screen may present the user with one or more views of a given project including, but not limited to, selection thumbnails “sanity,” “timeline” and “budget.” FIG. 3C depicts the thumbnails view according to an embodiment of the present disclosure. A graphic may be provided that may show the thumbnails as well as a timeline of the project and how many days have passed since the project began and/or how many days are remaining before the project is scheduled to be finished. It should be appreciated that the user may alter the timeline associated with the project in some embodiments of the present disclosure. Alterations may include changing the start date and the end date associated with the project.

The “sanity” view may allow the user to indicate how he/she is feeling about the project in real-time. In embodiments of the present disclosure, word descriptions and/or images may be selected to indicate the user's feelings about the project. These feelings may include, but are not limited to, “pure bliss,” “in the zone,” “holding it together,” “starting to lose my mind,” and/or “take me to the crazy house.” By allowing the user to change his/her “sanity” status in real-time, the user may give others working on the project (i.e., the architect, interior designer, and/or builder) an indication about how the user is feeling about the project. This may permit others to take actions to improve the user's feelings about the project, should the user's feelings need to be improved.

The “budget” view on the home screen may allow the user to enter the budget allotted for the project. The user also may enter/update expenses using this view. As expenses are updated, the user may be presented with a graphical representation of how the expenses are tracking relative to the budget. This “budget” view also may include numerical indicators of how much of the budget has been spent.

A user may be presented with an icon, such as the cloud icon or a method to invite collaborators depicted in FIG. 3B, and upon selection of that icon, the user may share his/her project with one or more users. The user may invite other users to view his/her project, and in some embodiments of the present disclosure, the other users may be prompted to download the application in order to be able to view the project (i.e., if they are new users). Selection of the cloud icon also may allow the user to see with whom he/she has shared the project. The user also may be presented with a “selections” icon to navigate his/her images within the application according to an embodiment of the present disclosure. While the collaborators screen is depicted in FIG. 3B, it should be appreciated that other icons or input mechanism may be utilized to allow the user to share his/her project and navigate his/her images respectively without departing from the present disclosure.

When a user selects the “selections” button or thumbnails in FIG. 3C, the user may be presented with a “selections” screen as depicted in FIG. 3C. The user may be presented with a “rooms” selection so that the user may view his/her images as they are organized based on the room. Additionally or alternatively, the user may be presented with categories including, but not limited to, inspirational images, biggies, appliances, backsplashes, built-ins, ceiling treatments, countertops, floor plan sketches, flooring, furniture, glass and mirrors, hardware, and interior doors. Upon selecting one of the categories, the user may view the images that have been associated with that category.

As depicted in FIG. 3C, user also may be presented with one or more additional icons, including, but not limited to, the “+” icon, the “camera” icon, and the “sheet” icon, in order to perform one or more additional functions. The “+” icon may allow the user to add more selections. The “camera” icon may allow the user to add additional images, either by taking a picture using the phone camera or by selecting one or more images from the image library. The “sheet” icon may be used for the user to send one or more specification sheets associated with the project.

When a user opts to view images by room, the user may be presented with a list of rooms associated with the project as depicted in FIG. 3D. It should be appreciated that the list of rooms may change depending on the type of project. In this embodiment of the present disclosure, the rooms may include, but are not limited to, entry, exterior, girl's shared bathroom, girl's shared bedroom, greatroom, guest bathroom, guest bedroom, kitchen, laundry room, master bath, master bedroom, mud room, spare bedroom, and staircase. Again, as discussed with respect to FIG. 3C, the user may be presented with options to add rooms (“+” icon), add photos (“camera” icon”) and send specs (“sheet” icon).

The user may select the plumbing as the category to be viewed, and FIG. 3E depicts a screenshot of how categories within rooms may be organized and images may be displayed in a spec sheet. In this embodiment of the present disclosure, the user has selected the “plumbing” and may be presented with labels including, but not limited to, powder bath, kitchen, bathroom, etc. It should be appreciated that there may be some embodiments of the present disclosure where a user may be presented with only the categories where images have been placed; however, there may be other embodiments of the present disclosure where the user may be presented with all categories that may be associated with the room that the user may elect to associate images with categories that have not been populated. In this embodiment of the present disclosure, thumbnails of the images associated with each category may be displayed. If the user wishes to look at a full view of the image, the user may click on the image that he/she would like to review. In this embodiment of the present disclosure, the user is again presented with the “sheet” icon and the “camera” icon so that he/she may create/send a specification sheet or upload a photo respectively.

FIG. 3F depicts a screenshot of an image that may have been selected by the user in FIG. 3E. In this embodiment of the present disclosure, the user may be presented with a larger view of the image. The user also may be presented with an icon, such as the tack depicted in FIG. 3F, that the user may select in order to add private notes about the image that may be included on a specification sheet. The user also may be presented with an icon, such as the star depicted in FIG. 3F, that the user may select to mark the image as a top choice. The user also may have the option to delete an image, such as by selecting the trashcan icon depicted in FIG. 3F. As depicted in FIG. 3F, the user may enter comments in the comments section that may be viewable by any users with whom the project is shared. Accordingly, if the user particularly likes the colors or the hardware depicted in the image, the user may include a comment to that effect so that his/her interior designer may get a better idea of what the user likes, should the user share the project with the interior designer.

In another embodiment, the invention can also relate to organization of various “projects” that are not related to the home building process. These projects may include recipes, hunting and fishing categories, family photographs, video and/or photographs from friends, clothing, maternity clothing, infant clothing, clothing accessories, inventory for insurance, interconnected projects and categories listed by location including but not limited to vacation or event places, party dish categories, decor or furnishing categories, lighting fixtures, personal data management including videos and/or photographs organized by project, and floral categories. It will be understood a person having skill in the art that photographs, data, text, or video can be in one “project” and also in other defined “projects.” The “projects” can be user-defined or administrator-defined. In additional each “project” can have sub-categories defined by a user or administrator. As part of the process, a graphical user interface is defined which includes a touchscreen or gesture-based interface. The graphical user interface may be curved, undulating, or flat in nature. The graphical user interface is configured to include a backdrop image or text-based system and then a dual-icon menu that is presented from a bottom-up presentation to the user. It will be understood that the graphical user interface can have one or more icons presented on a menu and the presentation of the menu can be horizontal, left-to-right, right-to-left, or top-down. Upon display of the dual-icon menu, the user can either select to upload or otherwise add a photograph or video to an existing “project” or sub-category using a first icon or using the second icon, define a project which may include any number of sub-categories. For example, if the user has defined a project as family pictures some examples of sub-categories could include family pictures, vacation pictures, sports pictures, fishing pictures, grandkid pictures, self portraits “selfies”, and any combination of these sub-categories. Thus, in this method the user would 1) define a “project” and any subcategories through the graphical user interface; 2) allow a photograph to be uploaded or tagged to a specific project and/or sub-category; 3) allow for the photograph or video clip to be sorted based upon parameters from the “project” or other text-based searches; and 4) allow for multi-level searches of multiple “projects” and sub-categories to locate images or videos that are relevant to the search. Thus, with this highly-unique interface and process for defining projects based upon a plurality of parameters per each project specification combined with the ability to perform multi-level searches for data, the disclosed embodiment presents a powerful combination of ease of use and personal management functionality. It will be acknowledged that this process can occur in certain number of specific steps or in another preferred embodiment in any order determined by the software or user.

A further problem the present invention addresses is linear searching of the prior art in that it uses a static “drill-down” type filtering that only narrows information as you search. The prior art lacks dynamic filtering that permits searching to enable more relevant and connected detail. The present invention provides an invertible organization of information. In one embodiment, the present invention filters and simultaneously expands the search results by permitting inversion of information.

In one example, a user may navigate to a website and be prompted to create a login. Once that login is created, the user may access templates, create or edit templates and add other users such as collaborators. A project can be created or already exist in a database. Each project 150 to 158 may have a name 151, identifiers or tags 200 and an item 300. Items 300 are in a nested format, for example, in mongodb. The items 300 are children to and added to projects 150 to 158.

Each project 150 to 158 will include identifiers or tags 200 of “what” categories or “where” labels which can be renamed or deleted. The “what” categories may also be called “hubs” or “hub/categories” and “where” labels may also be called “spokes” or “spokes/labels”. The user will then select “new” from any screen they are on so that they can add a photo, content, etc. When a user uploads content such as but not limited to media, images, video, documents, links etc., an entry or field is created in a project 150 to 158 within a database 100 for that content/media object with a random 1D assigned. The content may be re-sized for optimal viewing on various device screens. Specifically, each image the user uploads may be automatically resized into three different image sizes—one for thumbnail, one for scrolling and one high resolution for the tagging/zoom screen Once the image or content 312 is uploaded to the database 100, the user will see a tagging screen that allows the user to add identifiers or tags 200, notes 260 and links 270 as well as be able to produce products 400 such as spec sheets, PDFs moodboards, photo books, etc.

Regardless of the “what” category/hub or “where” label/spoke is selected, the user will be able to quickly toggle between these interconnected identifiers (or tags) to drill down and simultaneously expand the drilled down filter. In some embodiments, when one category or hub tag is selected, the label or spoke tags that are connected to the hub will be displayed. In another embodiment, one spoke may be selected (selected spoke) to display hubs and/or spokes connected to the selected spoke. Thus, when the user navigates and selects a hub, the thumbnail images of the spokes connected to that hub can be viewed. If the user then selects to view any image of a selected spoke, the tags interconnected with the selected spoke scan be displayed (either hubs or spoke) to open up content/images and take a closer look or to edit any of the notes or links or tags associated with the image. The user can also decide to produce products 400 such as a PDF documents, spec sheet, etc at any point along the search route in the invention to show thumbnails, notes 260 and links 270 of the results. As all tags or identifiers 200 in the project 1500 to 158 are interconnected, a user is able to quickly find images/content 312 from any screen using the present invention.

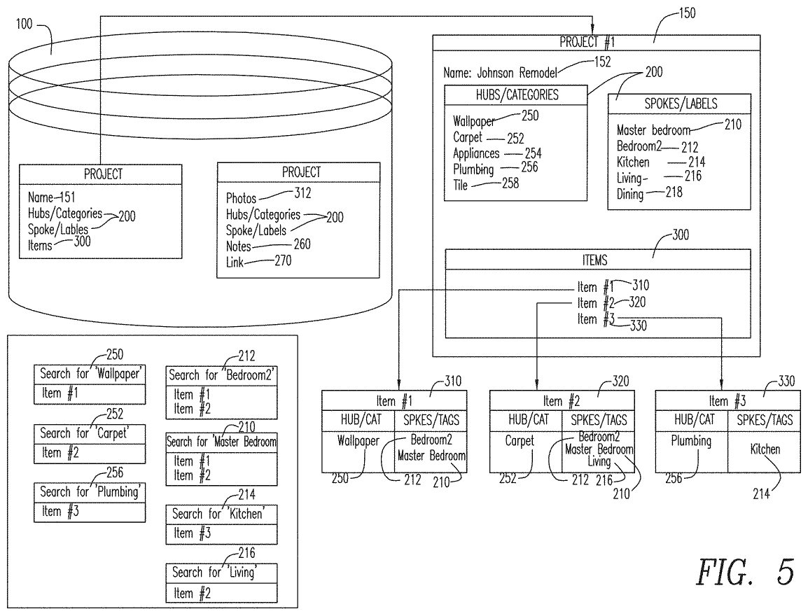

Looking at FIG. 4, a database 100 is shown with objects of saved projects 150-158. The database 100 will hold any number of objects/projects and for any topic such as but not limited to recipes, family photographs and/or videos, video and/or photographs from friends, clothing, accessories, vacation or event places, decor or furnishing categories, personal data management categories. For instance, project 150 may be a “home project” while project 152 may be for “family photographs”. Each project 150-158 contains tags or identifiers 200 of hubs and spokes. See FIG. 5. Specifically, each project can include name 151, tags or identifiers 200 of hub/categories and spokes/labels and items 300. The item 300 can include photos 312, tag or identifiers of hub/categories and spokes/labels 200, notes 260 and links 270. Notes 260 may include information relevant to the content in the item 300. Links 270 may provide space for website information and/or addresses. All identifiers 200 in the items 300 may be interconnected and gives the user the ability to quickly find the image/content from any point in the process. In other embodiments, at least one set of identifiers are interconnected. The interconnected identifiers 200 may be realized in the project item or item 300, see item 310, item 320 and item 330 for interconnections.

Said tags or identifiers 200 may be specific for each project and may be limitless. In the present example, project 150 has hubs 250 to 258 for wallpaper 250, carpet 252, appliance 254, plumbing 256 and tile 258 and spokes 210 to 218 for master bedroom 210, bedroom 212, kitchen 214, living room 216, dining room 218. Project 150 also has items 300 here being item 310, item 320 and item 330. Each item 300 includes any combination of the tags or identifier 200 of the project it is within. Item 310 has a hub of wallpaper 250 that is interconnected to the spokes of bedroom2 212 and master bedroom 210. Item 320 has a hub of carpet 252 that is interconnected to the spokes of bedroom2 212, master bedroom 210 and living room 216. Item 330 has a hub of plumbing 256 that is interconnected to the spoke of kitchen 214. The interconnectivity between the hub and spokes may be tagged by the user and then saved in each object/project, specifically within the specific item 300. The identifiers 200 of hub and spokes, items 300 may be specific to project 150 while other projects 152 to 158 have their own set of identifiers 200 that may or may not overlap.

Looking at FIGS. 4 and 5, when a user searches for carpet 252, a http get request is submitted to the API with a project id and the API returns the project entity data (such as name 151), including all identifiers 200 (hubs and spokes) and items 300 for the selected project. Once the user selects any identifier 200, the present invention will display items 300 related to or containing the identifier 200 (hub and spokes). The invention will loop through each item 300 in the project 150 and will check if the list of identifiers 200 (hubs and spokes) of that item 300 contains the identifiers 200 (hubs and spokes) the user selected and if it does, the invention will display this item 300. All the items 300 inside the project 150 inside the database 100 are looked at and asked if it has the selected identifier, the carpet 252. If the carpet 252 is not present in an item 300, then there is a pass. If it does have the carpet 252, the item is loaded on the screen.

Here the invention finds item 320 thereby producing three results of bedroom2 212, master bedroom 210 and living room 216. In one example code for the invention may be:

App code:

const labelOrCategoryName = ‘...’;
return project.items.filter(i => i.labels.includes(labelOrCategoryName) ∥
i.categories.includes(labelOrCategoryName));

From the results for carpet 252, if the user next selects to view bedroom2 212, the invention produces two results of carpet 252 from item 320 and wallpaper 250 from item 310. As evident here, the hub and spoke flips or inverts so now the spoke is searched to produce results. So the initial search for carpet 252 produces three spokes while the search for the bedroom2 212 produces two hubs one of which is the carpet 252 which was initially searched. See FIG. 4. Thus, the present invention provides search results that filter and simultaneously expands to include relevant information back into the results.

Looking at the lower part of FIG. 4, if a user searches for master bedroom 210 in Project 150, the hubs of wallpaper 250 and carpet 252 is produced. At this point products 400 maybe produced or another search can be run. The subsequent search of the carpet 252 produces three results bedroom2 212, living room 216 and master bedroom 210, each being spokes.

As seen above, the interconnection of the tags or identifiers 200 of hub(s) 210 to 218 to one or more spokes 250 to 258 enables inversion of these organizational units of identifiers or tags. The net effect is an unique presentation that allows the user to access information in a manner that is more efficient than other methods, while still being flexible enough to follow the user's specific workflow needs. Additionally, items 300 that are categorized with identifiers using the above system are able to be represented statically on-demand and shared via a generated document. The hierarchical nature of the items is “flattened” and rendered in list form with various media options, in one example the results may take the form of products 400 such as a PDF document, a spec sheets, moodbook. Thus, the user is able to export results to create dynamic spec sheets at any point in the invention. As a result of the technologically advancements in the present invention the insight into productive organizational methods is realized involving a curated, invertible system of categorization and labeling.

Looking at another example, where the invention relate to organization of projects unrelated to home projects shows a search of project 152, for “family photographs”. Project 152 will have a list of possible identifiers 200 of hub and spokes. For example, Project 152 may have spokes or Labels of label A, label B, label C and hub or Categories: cat 1, cat 2, cat 3 and Items 300 including Item 1 and Item 2. Each item 300 has a list of identifiers 200 (hub and spokes).

Item 1: which is a Photo and includes Hub/Categories: cat 1, cat 3 and Spoke/Label: label A, and

Item 2 which is a Photo and includes Hub/Categories: cat 1 and Spokes/Labels: label b, label C.

A search for “cat 1” returns Item 1 and Item 2. A search for “cat 1+label B” only returns Item 2 while a search for “cat 2” returns neither Item 1 nor Item 2

An Example Project Schema for the above may include:

project: {

name: ‘Project 1’,
labels: [‘label A’, ‘label B’, ‘label C’],
categories: [‘cat 1’, ‘cat 2’, ‘cat 3’],
items: [

{

photos: [{

filename: ‘photo.jpg’,
...,

}]
labels: [‘label C’],
categories: [‘cat 1’, ‘cat 2’],

},
{

photos: [{

filename: ‘photo_2.jpg’,
...,

}]
labels: [‘label A’, ‘label B’],
categories: [‘cat 1’, ‘cat 3’],

}

]

}

The present invention technologically improves the functioning of the computer by facilitating simultaneous narrowed and expanded searching.

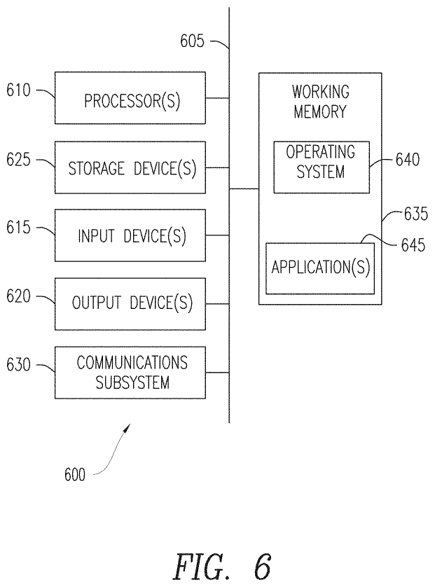

FIG. 6 illustrates a simplified computer system that can be used implement various embodiments described and illustrated herein. A computer system 600 as illustrated in FIG. 6 may be incorporated into devices such as a portable electronic device, mobile phone, or other device as described herein. FIG. 6 provides a schematic illustration of one embodiment of a computer system 600 that can perform some or all of the steps of the methods provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computer system 600 is shown comprising hardware elements that can be electrically coupled via a bus 605, or may otherwise be in communication, as appropriate. The hardware elements may include one or more processors 610, including without limitation one or more general-purpose processors and/or one or more special-purpose processors such as digital signal processing chips, graphics acceleration processors, and/or the like; one or more input devices 615, which can include without limitation a mouse, a keyboard, a camera, and/or the like; and one or more output devices 620, which can include without limitation a display device, a printer, and/or the like.

The computer system 600 may further include and/or be in communication with one or more non-transitory storage devices 625, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 600 might also include a communications subsystem 630, which can include without limitation a modem, a network card (wireless or wired), an infrared communication device, a wireless communication device, and/or a chipset such as a Bluetooth™ device, an 602.11 device, a WiFi device, a WiMax device, cellular communication facilities, etc., and/or the like. The communications subsystem 630 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 630. In other embodiments, a portable electronic device, e.g. the first electronic device, may be incorporated into the computer system 600, e.g., an electronic device as an input device 615. In some embodiments, the computer system 600 will further comprise a working memory 635, which can include a RAM or ROM device, as described above.

The computer system 600 also can include software elements, shown as being currently located within the working memory 635, including an operating system 640, device drivers, executable libraries, and/or other code, such as one or more application programs 645, which may comprise computer programs provided by various embodiments, and/or may be designed to implement methods, and/or configure systems, provided by other embodiments, as described herein. Merely by way of example, one or more procedures described with respect to the methods discussed above, such as those described in relation to FIG. 6, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 625 described above. In some cases, the storage medium might be incorporated within a computer system, such as computer system 600. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 600 to perform methods in accordance with various embodiments of the technology. According to a set of embodiments, some or all of the procedures of such methods are performed by the computer system 600 in response to processor 610 executing one or more sequences of one or more instructions, which might be incorporated into the operating system 640 and/or other code, such as an application program 645, contained in the working memory 635. Such instructions may be read into the working memory 635 from another computer-readable medium, such as one or more of the storage device(s) 625. Merely by way of example, execution of the sequences of instructions contained in the working memory 635 might cause the processor(s) 610 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 600, various computer-readable media might be involved in providing instructions/code to processor(s) 610 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 626. Volatile media include, without limitation, dynamic memory, such as the working memory 636.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600.

The communications subsystem 630 and/or components thereof generally will receive signals, and the bus 605 then might carry the signals and/or the data, instructions, etc. carried by the signals to the working memory 635, from which the processor(s) 610 retrieves and executes the instructions. The instructions received by the working memory 635 may optionally be stored on a non-transitory storage device 625 either before or after execution by the processor(s) 610.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks. Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

While systems and methods according to embodiments of the present disclosure have been described in the context of home building and remodeling projects, it should be appreciated that the systems and methods may be used for other applications without departing from the present disclosure.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

I claim:

1. A method of managing a project implemented on a server system comprising:
providing a database having at least one project, said project having project identifiers, said project identifiers being first identifiers and second identifiers, wherein said first identifiers and second identifiers are different from each other;
storing project items within said project, each said project item having at least one of said first identifier and having at least one of said second identifier, wherein at least one of said first identifier is interconnected to at least one of said second identifier in each said project item;
selecting at least a first project identifier from said project;
displaying said project items containing said selected project identifier as a first display;
selecting a second project identifier from said first display; and
displaying said project items containing said selected second project identifier as a second display.

2. The method of claim 1, further comprising presenting said first display as a product.

3. The method of claim 2, further comprising presenting said first display and said second display as a product.

4. The method of claim 2, wherein said product sorts said first display based on project item.

5. The method of claim 3, wherein said product sorts said first display and said second display based on project item.

6. The method of claim 2, wherein said product comprises PDF document, Spec sheet, photo album, moodboards.

7. The method of claim 1, wherein said project items in said second display includes at least one of said project items from said first display.

8. An information processing method operated by at least one processor by executing a program stored in at least one memory, the method comprising the steps of:
providing a database having at least one project, said project having project identifiers, said project identifiers being first identifiers and second identifiers, wherein said first identifiers and second identifiers are different from each other;
storing project items within said project, each said project item having at least one of said first identifier and having at least one of said second identifier, wherein at least one of said first identifier is interconnected to at least one of said second identifier in each said project item;
selecting at least a first project identifier from said project;
displaying said project items containing said selected project identifier as a first display;
selecting a second project identifier from said first display;
displaying said project items containing said selected second project identifier as a second display, wherein said project items in said second display may include at least one of said project items from said first display; and
presenting said first display as a product.

9. The method of claim 8, further comprising presenting said first display and said second display as a product.

10. The method of claim 8, wherein said product sorts said first display based on project item.

11. The method of claim 9, wherein said product sorts said first display and said second display based on project item.

12. The method of claim 9, wherein said product comprises PDF document, Spec sheet, photo album, moodboards.
